(19) United States
(12) Patent Application Publication
(10) Pub. No.: US 2026/0028478 A1
(43) Pub. Date: Jan. 29, 2026

(54) METHOD OF PRODUCING A POLYLACTIC ACID (PLA)-BASED MATERIAL

(71) Applicant: TECHNISCHE UNIVERSITEIT EINDHOVEN, Eindhoven (NL)

(72) Inventors: Hamid AHMADI, Eindhoven (NL); Ruth Maria CARDINAELS, Eindhoven (NL); Patrick David ANDERSON, Eindhoven (NL)

(21) Appl. No.: 18/997,896

(22) PCT Filed: Aug. 1, 2023
(86) PCT No.: PCT/NL2023/050408

§ 371 Date: Jan. 23, 2025

(30) Foreign Application Priority Data
Aug. 4, 2022 (NL) 2032681

(51) Int. Cl. C08L 67/04; C08J 3/00

(52) U.S. Cl. CPC C08L 67/04; C08J 3/005; C08L 2203/12; C08L 2203/16

(57) ABSTRACT

A method of producing a polylactic acid (PLA)-based material comprising the steps of: a) providing an amorphous blend comprising poly(L-lactic acid) (PLLA) and poly(D-lactic acid) (PDLA); b) bringing the blend provided in step (a) to a temperature (TC,HC) of between glass transition temperature (Tg) and homocrystalline phase melting temperature (Tm,HC) and maintaining the temperature within this range until at least 5 J/g of homocrystallites are formed with a melting temperature below 180° C.; and c) bringing the resulting material of step (b) to a temperature (TSC) above melting temperature of homocrystalline phase and maintaining the temperature within this range for a sufficient time tSC to generate a poly(lactic acid)-based material with nano-sized stereocomplex crystals having a melting temperature higher than Tm,HC. A PLA-based material obtained or obtainable via said method.

### TECHNICAL FIELD

The present invention relates to a method of producing a polylactic acid (PLA)-based material. The invention further relates to a PLA-based material. The invention further relates to a fiber, film, foam or sheet comprising the polylactic acid (PLA)-based material, and to a method of producing such fiber, film, foam or sheet. The invention further relates to use of the PLA-based material in packaging, automotive parts, textiles, medical equipment, agricultural equipment and electronical equipment.

### BACKGROUND

Petroleum-based plastics have been mass-produced because they are light, tough, durable, and can be easily processed. Therefore, they have supported our lives in many ways. In spite of this, petroleum-based polymers accumulate without easily decomposing when disposed of in the environment. Further, they release a large amount of carbon dioxide when burned, which accelerates global warming. As a result, resins made from biodegradable plastics are being actively investigated. Polylactic acid (PLA) based materials are a sort of thermoplastic aliphatic polyester produced from renewable resources, such as corn starch, potato, or sugarcane that have the potential to replace petroleum-based plastics because they are easily degraded by microorganisms.

In applications such as film blowing, thermoforming, and injection molding, PLA-based materials are becoming increasingly popular because of a rising preference for renewable resources. However, PLA's moderate thermal and rheological properties at elevated temperatures pose an important disadvantage in such applications. PLA, for example, has a moderate melt strength above its melting point, resulting in an unstable blowing process when used in film blowing or thermoforming. Moreover, PLA-based materials have a relatively low heat deflection temperature above PLA's glass transition temperature. As a result, PLA resins are generally not suitable for applications such as handling hot foods or for microwave food packaging. Different modification techniques can be utilized to mitigate the disadvantages of PLA-based materials discussed previously. The majority of these modification methods, however, will not only increase the complexity of the operation process and production costs, but also damage the biodegradability of PLA-based materials and make its recycling more difficult.

A common green approach to resolve the aforementioned issues is to embed stereocomplex structures in PLA-based materials. PLLA (left-handed polylactic acid) and PDLA (right-handed polylactic acid) represent two optical isomers of PLA. They can be tightly packed together through the formation of hydrogen bonds between molecular chains to form stereocomplex crystals (SC) with a melting point of about 50° C. higher than the melting point of homocrystals generated from PLLA or PDLA. Hence, the presence of stereocomplex structures in the melt and solid states is considered to be one of the most simple and effective methods to achieve high performance of PLA-based materials.

US2021155796A1 discloses a process for producing poly(lactic acid)-based material including a melt stretching step and a crystallization step.

US2016272811 discloses a polylactic acid stereocomplex composition containing pure stereocomplex crystals and a process for its manufacture.
US2010152415 discloses a process for producing transparent thermoformed PLA items with improved thermal properties by pre- or post-heating treatment.

A number of factors have made this approach unsatisfactory in practice. The low rate of stereocomplex crystallization, for example, adds to processing time, lowering production rates and increasing costs. Further, highly crystallized PLA resins tend to become unstable in the melt state and opaque in the solid state. Additionally, the toughness of crystalized PLA is largely determined by the shape, size and number of crystallized phases.

Therefore, there is a need for a method to produce PLA products with SC crystals that have good rheological, mechanical and/or optical properties at acceptable production rates and processing conditions.

### SUMMARY

It is an object of the present invention to provide an improved method of manufacturing a PLA-based material.

It is a further object of the present invention to provide a PLA-based material that has improved rheological, mechanical and/or optical properties.

The invention relates in a first aspect to a method of producing a polylactic acid (PLA)-based material comprising the steps of: a) providing an amorphous blend comprising poly(L-lactic acid) (PLLA) and poly(D-lactic acid) (PDLA); b) bringing the blend provided in step (a) to a temperature (T_{C,HC}) of between glass transition temperature (T_{g}) and homocrystalline phase melting temperature (T_{m,HC}) and maintaining the temperature within this range until at least 5 J/g of homocrystallites are formed with a melting temperature below 180° C.; and c) bringing the resulting material of step (b) to a temperature (T_{SC}) above the melting temperature of homocrystalline phase and maintaining the temperature within this range for a sufficient time t_{SC} to generate a poly(lactic acid)-based material with nano-sized stereocomplex crystals having a melting temperature higher than Tm, HC.

The invention relates in a second aspect to a PLA-based material obtained or obtainable with the method according to the first aspect.

The invention relates in a third aspect to a PLA-based material comprising poly(L-lactic acid) (PLLA) and poly(D-lactic acid) (PDLA) and/or copolymers thereof, wherein the material contains at least 2% by weight of nano-sized stereocomplex crystals, based on the total weight of the material.

The invention relates in a fourth aspect to a PLA-based material comprising poly(L-lactic acid) (PLLA), poly(D-lactic acid) (PDLA); wherein the combined weight of PLLA and PDLA forms at least 80 wt. % of the total weight of the material; and wherein the material has a Heat Deflection Temperature of above 115° C.; and/or a melt strength of above 5.6 MPa at 190° C.; and/or drawability of more than 40% at 190° C.; and/or the material is optically clear.

The invention relates in a fifth aspect to a PLA-based material comprising poly(L-lactic acid) (PLLA), poly(D-lactic acid) (PDLA), wherein the combined weight of PLLA and PDLA forms at least 80 wt. % of the total weight of the material, and wherein a sample of the PLA material exhibits strain-hardening behaviour when subjected to strain or deformation at a temperature above 160° C., and wherein the same sample of the PLA material no longer exhibits strain-hardening behaviour when subjected to strain or deformation subsequent to being heated to a minimum temperature of 210° C.

The invention relates in a sixth aspect to a fiber, film, foam or sheet comprising the polylactic acid (PLA)-based material according to any of the second to the fifth aspect.

The invention relates in a seventh aspect to a method of producing the fiber, film, foam or sheet according to the sixth aspect.

The invention relates in a eight aspect to use of the PLA-based material according to any of the second to the fifth aspect in packaging, automotive parts, textiles, medical equipment, agricultural equipment and electronical equipment. At least one of above-mentioned objects will be achieved by the method according to the present invention. Without wishing to be bound by theory, the inventors believe that the generation of nano-sized stereocomplex crystals through melting and recrystallization of homocrystals at specific PLLA/PDLA ratios and temperature conditions permits the manufacturing of improved PLA-based materials. These materials may be used commercially in applications such as film blowing, thermoforming, foaming, filament extrusion, additive manufacturing or injection molding.

Embodiments for one aspect are applicable correspondingly for the other aspects according to the present invention.

### BRIEF DESCRIPTION OF DRAWINGS

The present invention is described hereinafter with reference to the accompanying drawings in which embodiments of the present invention are shown and in which like reference numbers indicate the same or similar elements.

FIG. 1 shows the peak of crystallization temperature (T_{c peak}) during non-isothermal crystallization step as a function of self-nucleation temperature.

FIG. 2 is an atomic force microscopy (AFM) image of the nano-sized stereocomplex crystals formed via the method according to the present invention.

FIG. 3 shows the stereocomplexation at 190° C. from homocrystals formed at different temperatures according to Example 1, 2, and 3.

FIG. 4 shows the 2D WAXD patterns during the treatment process at 190° C. of the products of Examples 1, 2, and 3, which were taken at the time indicated in the images.

FIG. 5 shows the rheological behaviour of neat PLA (Luminy® L175) and the product of Example 4 under uniaxial extensional flow at 190° C.

FIG. 6 shows sufficient melt strength under uniaxial extensional flow in product of Example 4 (Strain at break=370%), and insufficient melt strength under extensional flow in neat PLA (Luminy® L175) (Strain at break=40%).

### DESCRIPTION OF EMBODIMENTS

### Method of Producing a PLA-Based Material

As stated above, the invention relates in a first aspect to a method of producing a polylactic acid (PLA)-based material comprising the steps of: a) providing an amorphous blend comprising poly(L-lactic acid) (PLLA) and poly(D-lactic acid) (PDLA); b) bringing the blend provided in step (a) to a temperature (T_{C,HC}) of between glass transition temperature (T_{g}) and homocrystalline phase melting temperature (T_{m,HC}) and maintaining the temperature within this range until at least 5 J/g J/g of homocrystallites are formed with a melting temperature below 180° C.; and c) bringing the resulting material of step (b) to a temperature (T_{SC}) above melting temperature of homocrystalline phase and maintaining the temperature within this range for a sufficient time t_{SC} to generate a poly(lactic acid)-based material with nano-sized stereocomplex crystals having a melting temperature higher than T_{m,HC}.

In some embodiments, the temperature is maintained within the described range until at least 20 J/g of homocrystallites are formed with a melting temperature below 180° C. In other embodiments this is at least 30 J/g, and in further embodiments 5-50 J/g.

In the context of the present disclosure, the term “nano-sized” refers to stereocomplex crystals, as that term would be understood by those of ordinary skill in the art, that have at least one dimension measuring no more than 100 nm.

The amount of homocrystallites formed in step b) may be measured by techniques known to the skilled person, such as calorimetry or X-ray diffraction. An amount of at least 5 J/g of homocrystallites in step b) is required because this allows to control the kinetics and amount of the nano-sized stereocomplex crystals which is generated in step c).

It is possible that step c) does not directly follow step b), but that the obtained material is allowed to cool in between, for instance to room temperature. This allows for transportation of the material obtained in step b) prior to applying step c).

In an embodiment of the first aspect, in step (a) the blend is provided via melt blending or solvent mixing.

In an embodiment of the first aspect, the amorphous blend has weight ratio of PLLA:PDLA of between 5:95 and 95:5.

In an embodiment of the first aspect, the amorphous blend has weight ratio of PLLA:PDLA of between 5:95 and 12:88 or between 95:5 and 88:12. In other words, there is between 5-12 wt. % of either PLLA or PDLA, and between 88-95 wt. % of PDLA or PLLA, respectively, based on the combined weight of PLLA and PDLA in the blend. In a specific embodiment, the amorphous blend has weight ratio of PLLA:PDLA of between 5:95 and 8:92 or between 95:5 and 92:8.

In an embodiment of the first aspect, T_{C,HC} is between 70° C. and 155° C. to ensure homocrystallization. In a specific embodiment, T_{C,HC} is between 80° C. and 130° C., and in a more specific embodiment, T_{C,HC} is between 90° C. and 120° C.

In an embodiment of the first aspect, T_{SC} is between 170° C. and 230° C. to ensure the forming of nano-sized stereocomplex crystals. In a specific embodiment, T_{SC} is between 180° C. and 210° C. In more specific embodiment, T_{SC} is between 185° C. and 205° C., or even more specific between 190° C. and 200° C., such as 190° C.

In an embodiment of the first aspect, in step b) the blend is maintained at the temperature (T_{C,HC}) for at least 2 minutes. This is to allow for the formation of at least 5 J/g of homocrystallites with a melting temperature below 180° C.

In an embodiment of the first aspect, in step c) the time t_{SC} is at least 30 seconds. This allows for the formation of nano-sized stereocomplex crystals. The optimum time t_{SC} depends on the ratio of PLLA to PDLA and homocrystallization temperature (i.e. type of homocrystal which is formed in step b). If the difference between the amounts of PLLA and PLDA is larger (e.g. 5:95 or 95:5), a longer time t_{SC} is required than if the differences between the amounts is smaller (e.g. 12:88 or 88:12).

In an embodiment of the first aspect, PLLA and PDLA in the amorphous blend are independently chosen from linear, branched or multibranched PLLA and PDLA resin.

In an embodiment of the first aspect, the blend provided in step (a) comprises a linear, branched or multi-branched PLLA resin with an average molecular weight of more than 30 kDa, preferably more than 50 kDa, more preferably more than 70 kDa, even more preferably more than 100 kDa, most preferably more than 120 kDa.

In an embodiment of the first aspect, the blend provided in step (a) comprises a linear, branched or multi-branched PDLA resin with an average molecular weight of 0.5-500 kDa. In a specific embodiment, the average molecular weight is more than 30 kDa, preferably more than 50 kDa, more preferably more than 70 kDa, even more preferably more than 100 kDa, most preferably more than 120 kDa.

In an embodiment of the first aspect, the amorphous blend further comprises a copolymer of PLLA and PDLA.

In an embodiment of the first aspect, the amorphous blend further comprises one or more components, e.g., additives, such as nucleating agents, stabilizers, processing aids, etc. Exemplary components are selected from the group of: minerals, fillers, fibers; and waste streams from agriculture. Examples of such waste streams are material extracted from husk (coffee or rice husk flour) or leaves or wood. In addition to these materials, nanoparticles, nanofibers or nanocrystals such as nanoclay or nanocellulose may be added. The fillers may be organic or inorganic fillers. The fibers may be organic or inorganic fibers, and they may be manufactured fibers.

In an embodiment of the first aspect, the method further comprises a step of uniaxially and/or biaxially stretching of the material before, during and/or after step (b) and/or step (c). In the method according to the invention, stretching is not necessary to obtain a PLA-based material with the desired properties. However, stretching may take place nonetheless.

### PLA-Based Material

As stated above, the invention relates in a second, third, fourth, and fifth aspect to a polylactic acid-based material. According to the second aspect of the present disclosure, the PLA based material is obtained or obtainable via the method according to the first aspect. In some embodiments of the third, fourth and/or fifth aspect, the PLA based material is obtained or obtainable via the method according to the first aspect.

The new PLA based materials overcome the shortcomings of the traditional PLA by providing a more superior combination of rheological, mechanical, chemical, optical and/or other useful properties.

Exemplary PLA based materials according to the present disclosure include nano-sized stereocomplex crystals.

According to the third aspect, the PLA based material comprises poly(L-lactic acid) (PLLA) and poly(D-lactic acid) (PDLA) and/or copolymers thereof, wherein the material contains at least 2% by weight of nano-sized stereocomplex crystals, based on the total weight of the material.

In an embodiment of the third aspect, the material contains at least 5% by weight, preferably at least 10% by weight, more preferably at least 20% by weight of nano-sized stereocomplex crystals, based on the total weight of the material.

It is believed that the presence of nano-sized stereocomplex crystals results in improved PLA-based materials by adding a new physical characteristic to the material. The presence of nano-sized stereocomplex crystals may be detected using a number of suitable techniques, such as TEM (Transmission Electron Microscopy), AFM (Atomic Force Microscopy) and SAXS (Small-Angle X-ray Scattering). For example, FIG. 2 is an atomic force microscopy (AFM) image showing nano-sized stereocomplex crystals comprised in exemplary PLA based materials according to the present invention. In some exemplary embodiments, the nano-sized stereocomplex crystals have at least one dimension measuring no more than 50 nm or no more than 30 nm, or from 10 nm to 30 nm.

The amount of nano-sized stereocomplex crystals can be determined using WAXD (Wide-Angle X-ray Diffraction) and DSC (Differential Scanning calorimetry) techniques. Amounts of nano-sized stereocomplex crystals in exemplary embodiments of the present disclosure, at which improvement can be seen, include, for example, at least 2 wt % or at least 5 wt %, based on the total weight of the material. However, the optimal amount will vary depending on the specific application, process conditions, and the amounts and types of the constituent materials and additives. Different applications may also necessitate different amounts of nano-sized stereocomplex crystals in the system to achieve the desired enhancements.

In an embodiment, such as those of the second, third, fourth, and/or fifth aspect according to the present disclosure, the material comprises less than 20 wt. % of additives of the total weight of the material. For example, the material may comprise at most 15 wt. %, at most 10 wt. %, at most 5 wt. %, or at most 1 wt. % or even no detectable additives. Although in the specific examples of the present disclosure, PLA based material comprises no external additives, it is common practice in the polymer industry to incorporate certain additives, such as antioxidants or processing aids. The addition of these additives in exemplary embodiments of the present disclosure can be done advantageously at a relatively low concentration, such as less than 1 wt %.

Examples of additives that could be used in some embodiments of the present disclosure include inorganic nucleating agents, such as talc, montmorillonite clay, or nanoscale particles, e.g., titanium dioxide (TiO2), which can enhance PLA's crystallization rate and increase its stiffness. Organic nucleating agents like organic salts or aromatic compounds, such as sorbitol or benzotriazole derivatives, can also act as nucleating agents, improving PLA's crystallinity and heat resistance. Other examples include polymers such as Poly (butylene adipate-co-terephthalate) (PBAT), Poly (lactic acid-co-glycolic acid) (PLGA); chain extenders such as Diisocyanates, Hydroxyl-terminated compounds and Maleic anhydrides; fillers such as Carbonate calcium, TiO₂, glass fibers and carbon-based additives (e.g., carbon nanotubes, carbon black, etc.); processing aids such as plasticizers; and lubricants, and/or stabilizers such as antioxidants and UV-stabilizers.

In a further embodiment, such as those of the second, third, fourth and/or fifth aspect, the weight ratio of PLLA:PDLA is between 5:95 and 95:5, and the combined weight of PLLA and PDLA forms at least 80% or more of the total weight of the material. It can also be said that the material comprises PLLA, PDLA and/or copolymers thereof at a combined weight of least 80 wt. % or more (for example 85 wt. %, 90 wt. %, 95 wt. % or 99 wt. % or more) of the total weight of the material.

PLA based materials according to certain aspects of the present disclosure have improved thermal and rheological properties at elevated temperatures. In particular, when PLA forms nano-sized stereocomplex crystals, the resulting material demonstrates an elevated melting temperature. This characteristic offers several advantages in terms of enhancing the thermal stability and processability of the materials. Specifically, the intermolecular interaction between PLLA and PDLA within the nano-sized stereocomplex crystals (SCs) creates a physical network that helps preserve the material's structure during processing. As a result, there is a reduction in changes to melt viscosity and improved resistance to degradation or flow instability at high processing temperatures (190°−210° C.). Moreover, the presence of nano-sized stereocomplex crystals induces shear thinning behaviour in the material. This means that as the shear rate increases, the viscosity of the material decreases. This property facilitates better flow during processing, enabling improved mould filling, fiber spinning, and/or filament extrusion. Furthermore, the physical network formed by the nano-sized stereocomplex crystals in the molten state enhances the melt strength and drawability of the material. It is also expected to reduce die swell and impact wall slip, leading to improved dimensional control and surface finish of the processed PLA-based materials.

PLA based materials according to certain aspects of the present disclosure have improved melt strength at the processing temperature. The term “melt strength” is commonly used to describe the extension load at the point of melt strip fracture. It is an important rheological parameter that characterizes the ability of polymer melts to resist extension deformation in processes such as spinning, blow moulding, and foaming. Superior performance of exemplary materials of the present disclosure is shown, for example, in FIG. 6, which represents a comparison of the sample prepared according to a method of the present disclosure to pure PLA, focusing on the amount of melt strength and drawability at 190° C. In FIG. 6, the stress at break of samples containing nano-sized stereocomplex crystals (SCs) is shown to be 6.04 MPa, while pure PLA exhibits a stress at break of 5.6 MPa. Additionally, the drawability, or strain at break, increases significantly from 40% at 190° C. for pure PLA to 370% for exemplary PLA based materials of the present disclosure, indicating a tenfold improvement.

Thus, the proposed technique of the present disclosure stands out among the traditional methods by offering a holistic improvement in melt strength, HDT, thermal stability, mechanical properties, and gas barrier properties, all without the necessity to introduce substantial amounts of external additives that compromise the biocompatibility and compostability of the PLA-based materials. In some exemplary embodiments of the present disclosure, these improvements are achieved without any need for external additives. This is a significant advantage, as it allows for the preservation of the desirable properties of PLA while simultaneously enhancing multiple performance aspects.

Additionally or alternatively, exemplary PLA based materials according to the present disclosure exhibit strain-hardening behaviour when subjected to strain or deformation at a temperature above 160° C. The term “strain hardening behaviour” refers to the material's ability to enhance strength and resistance to deformation as the applied strain or deformation increases and can be identified through a controlled extension force applied to the sample. The resulting elongational viscosity or elongational modulus is determined under extensional flow conditions using, for example, Sentmanat Extensional Rheometry add-on (SER) or ISO 16790 test method. Upon subjecting the same sample of the exemplary PLA based material to strain or deformation subsequent to being heated to a minimum temperature of 210° C. and repeating the test, a discernible decline in the melt strength may be observed, accompanied by the absence of strain-hardening behaviour.

Thus, in a further embodiment of any applicable aspect according to the present disclosure, the PLA-based material has a Heat Deflection Temperature of above 115° C., preferably above 120° C., more preferably above 130° C. In some embodiments, the HDT is between 115° C. and 140° C.

In a further embodiment of any applicable aspect, the material is optically clear, preferably having a haze value of less than 20%.

In a further embodiment of any applicable aspect, the material has a melt strength above 5.6 MPa at 190° C., preferably above 6.04, and/or drawability of more than 40% at 190° C., preferably of 370% or more.

In a further embodiment of any applicable aspect, the PLA material exhibits strain-hardening behaviour when subjected to strain or deformation at a temperature above 160° C., such as at a temperature of above 160° C. and at most 210° C.

PLA based materials according to certain aspects of the present disclosure have higher Heat Deflection Temperature (HDT) above PLA's glass transition temperature.

As stated above, the invention relates in a fourth aspect to a PLA based material comprising poly(L-lactic acid) (PLLA), poly(D-lactic acid) (PDLA); wherein the combined weight of PLLA and PDLA forms at least 80 wt. % of the total weight of the material; and wherein the material has a Heat Deflection Temperature (HDT) of above 115° C.; and/or a melt strength of above 5.6 MPa at 190° C.; and/or drawability of more than 40% at 190° C.; and/or the material is optically clear.

In an embodiment, the PLA-based material is optically clear. This is opposite of the material being opaque. The transparency of the material can be characterized using Haze measurement or transmittance spectroscopy. A Haze meter, commonly used in transparent materials analysis (ASTM D1003), quantifies haze by calculating the percentage of light scattered at large angles. Lower haze values indicate higher transparency. In the case of PLA, the presence of a crystalline phase is necessary for various applications and neat crystallized PLA typically exhibits low transparency due to the presence of large spherical crystals, resulting in low transmission and high haze values (typically, above 50%). Crystallization in PLA usually results in the formation of micro-sized crystals that scatter light to a considerable extent. In contrast, by incorporating 5% nano-sized SCs into the material, it is anticipated that the haze value will be lower than 10%. In comparison, using the same amount of micronized crystals would likely result in a higher haze value, exceeding around 20%.

As stated above, the invention relates in a fifth aspect to a PLA based material comprising poly(L-lactic acid) (PLLA), poly(D-lactic acid) (PDLA), wherein the combined weight of PLLA and PDLA forms at least 80 wt. % of the total weight of the material, and wherein a sample of the PLA material exhibits strain-hardening behaviour when subjected to strain or deformation at a temperature above 160° C., and wherein the same sample of the PLA material no longer exhibits strain-hardening behaviour when subjected to strain or deformation subsequent to being heated to a minimum temperature of 210° C.

In some embodiments of the PLA based material, the material comprises a plurality of nano-sized stereocomplex crystals that are deformed, elongated and/or oriented along the same direction.

The PLA-based materials produced according to the methods of the invention are more capable of being stretched uniaxially or biaxially, which is not the case with pure PLA. Stretching can impart advantageous properties that include improved gas barrier properties, as well as increased tensile strength, stiffness, and toughness. When a film containing nano-sized stereocomplex crystals is stretched, various physical parameters undergo changes. The stretching process induces modifications in the crystalline structure of the polymer film, promoting the alignment of crystalline domains and enhancing the overall crystallinity of the material. Additionally, stretching can impact the size and shape of the crystalline domains or individual crystallites within the film. In certain cases, stretching leads to the elongation, deformation, and/or orientation of individual crystallites along a particular direction. By employing characterization techniques such as small-angle X-ray scattering (SAXS), transmission electron microscopy (TEM), or atomic force microscopy (AFM), one can detect the presence and degree of elongation, deformation, and/or orientation of constituent structures in PLA-based materials along a particular direction, after uniaxial or biaxial stretching.

Thus, the present disclosure provides a possibility to concurrently enhance multiple properties of PLA-based materials. While various methods exist for modifying the melt strength of PLA that include the use of chemical agents and chain extenders, the presently proposed technique not only enhances melt strength but also simultaneously improves thermal stability and mechanical properties. Importantly, the PLA materials of the present disclosure are expected to be biodegradable and compostable.

The skilled person will appreciate that embodiments relating to the third aspect, are applicable correspondingly to the fourth and fifth aspect; embodiments of the fourth aspect are applicable correspondingly to the third and fifth aspect; and embodiments of the fifth aspect are applicable correspondingly to the third and fourth aspect. In addition it is explicitly noted that a PLA based material may be according to more than one aspect. For example, the material may be according to the third and fourth aspect, the fourth and fifth aspect, the third and fifth aspect, or even according to the third, fourth and fifth aspect.

### Fiber, Film, Foam or Sheet

As stated above, the invention relates in another aspect to a fiber, film, foam or sheet comprising the PLA-based material according to the second aspect. In an embodiment of this aspect, the fiber, film, foam or sheet further comprises one or more components selected from the group of: minerals, fillers, fibers, and waste streams from agriculture. The fillers may be organic or inorganic fillers. The fibers may be organic or inorganic fibers, and they may be manufactured fibers.

### Method of Manufacturing of a Fiber, Film, Foam or Sheet

As stated above, the invention relates in yet another aspect to a method of manufacturing of a fiber, film, foam or sheet according to the third aspect.

This method comprises film blowing, thermoforming, foaming, filament extrusion, additive manufacturing and/or injection moulding of the polylactic acid-based material according to the second aspect.

### Use of the Polylactic Acid-Based Material

As stated above, the invention relates in an aspect to the use of the polylactic acid-based material according to the present disclosure. The PLA-based material may be used in packaging, automotive parts, textiles, medical equipment, agricultural equipment and electronical equipment. The fiber, film, foam or sheet according to the present disclosure may also be used in packaging, automotive parts, textiles, medical equipment, agricultural equipment and electronical equipment.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

The scope of the present invention is defined by the appended claims. One or more of the objects of the invention are achieved by the appended claims.

### EXAMPLES

The present invention is further elucidated based on the Examples below which are illustrative only and not considered limiting to the present invention. Following are examples of PLA-based material prepared using a batch mixer. The materials used in the samples are listed below. All values for physical properties and compositions are approximate unless otherwise stated.

PLLA: a polylactic acid polymer resin having a L-lactic acid content more than 99%, a melt flow index of 8 g/10 min (190° C./2.16 kg), and that is available from Total Corbion (The Netherlands) under the trade name Luminy® L175.

PDLA: a polylactic acid polymer resin having a D-lactic acid content more than 99%, a melt flow index of 10 g/10 min (190° C./2.16 kg), and that is available from Total Corbion (The Netherlands) under the trade name Luminy® D120.

### Example 1

50 and 50 parts by mass of each of fully vacuum-dried PLLA and PDLA were melt-blended under nitrogen flow at 240° C. in a DSM Xplore micro 15 cc twin-screw compounder (DSM, The Netherlands) with a rotating speed of 50 rpm for 10 minutes, and then extruded out, cooled in air, and pelletized. A predetermined amount of vacuum-dried PLLA/PDLA blends was compression molded into a sheet with a thickness of 0.5 mm at 260° C., immediately placed in a preheated oven at 100° C., and crystallized for about 10 minutes. To obtain PLA-based material with nano-sized stereocomplex crystals, the material was transferred into a second preheated oven at 190° C. and treated for approximately 5 minutes. All materials and samples were dried in a vacuum oven at 40° C. prior to processing and testing. The compression molded sheet was cut to provide a sample for heat deflection temperature (HDT) testing. HDT testing was performed under ISO 75-1:2020 (Method B).

### Example 2

The procedure of Example 1 was repeated except that after compression molding at 260° C., the material was immediately transferred to a preheated oven at 120° C. and crystallized for about 10 minutes, followed by treatment at 190° C. for about 5 minutes.

### Example 3

The procedure of Example 1 was repeated except that after compression molding at 260° C., the material was immediately transferred to a preheated oven at 80° C. and crystallized for about 20 minutes, followed by treatment at 190° C. for about 5 minutes.

### Results

Highest crystalline melting temperature (H.M.T), stereocomplex crystallinity (Xc) and HDT were measured in each resulting material. Table. 1 provides the results.

TABLE 1

| Samples | H.M.T (° C.) | Xc (%) | HDT(° C.) |
|---|---|---|---|
| Example 1 | 220 | 13.8 | 123 |
| Example 2 | 218 | 11.4 | 121 |
| Example 3 | 216 | 10.3 | 116 |

Since stereocomplex crystals can act as a nucleating agent for HCs, the structure of generated SC at different temperatures can be evaluated by determining the peak of crystallization temperature (Tc peak) during non-isothermal crystallization step. Accordingly, presence (amount, purity, etc.) of SC is evaluated from the position of Tc peak determined by employing the typical self-nucleation protocol using DSC test, under nitrogen flow. This protocol consists of several steps; after removing the thermal history of sample by heating to 270° C. for 1 min, it was cooled down to room temperature at 10° C./min, then heated to a temperature denoted self-nucleation temperature. The sample was kept at this temperature for 5 min and cooled down to room temperature at 10° C./min.

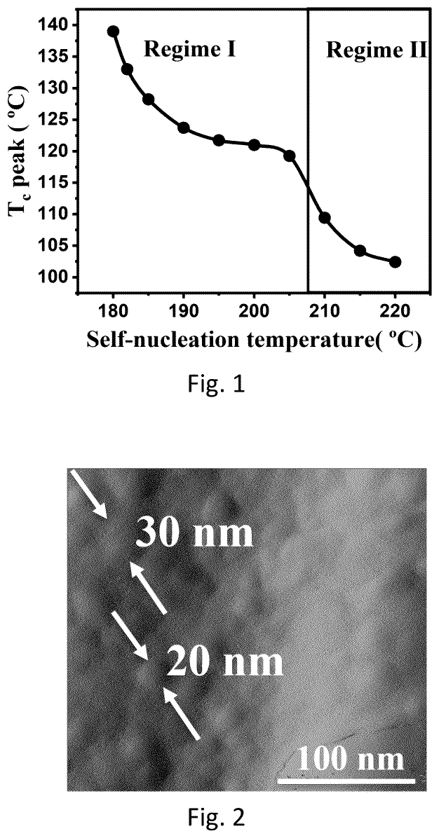

FIG. 1 illustrates the peak of crystallization temperature obtained during the second cooling versus selected self-nucleation temperatures (180-220° C.) for the PLLA/PDLA blend of Example 1. The nano-sized stereocomplex crystal, as can be seen in FIG. 2, can only be formed in the regime (I).

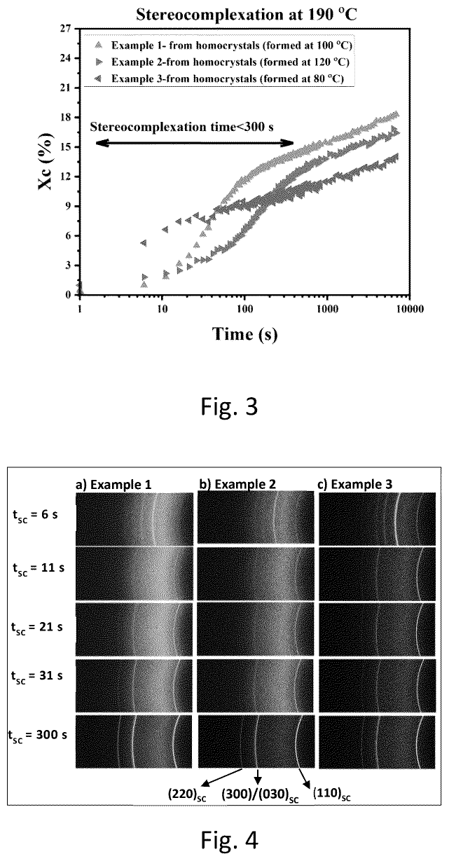

Moreover, in order to confirm further that the PLA-based material prepared in the present invention is conducive to the rapid formation of stereocomplex crystals, the crystallization kinetics and crystal structure of the PLLA/PDLA blend processed according to Example 1, 2 and 3 were investigated by wide-angle X-ray diffraction (WAXD) technique. A custom-built JHT-350 temperature-jump stage (Linkam) was used in order to reach a specific target temperature in the treatment steps. Using this device, the sample is heated in two separately controlled stages, allowing it to be quickly moved from one stage to another while constantly under temperature control. The cold stage was set at the desired temperature for crystallization (80-100-120° C.), and the hot stage was set at 260° C. or 190° C. A remotely controlled and air pressure driven actuator, attached to the steel slide, was added to quickly convey the sample back and forth between the stages at repeatable speed. The kinetics of stereocomplexation and 2D WAXD patterns during treatment process at 190° C. are shown in FIG. 3 and FIG. 4 respectively.

### Example 4

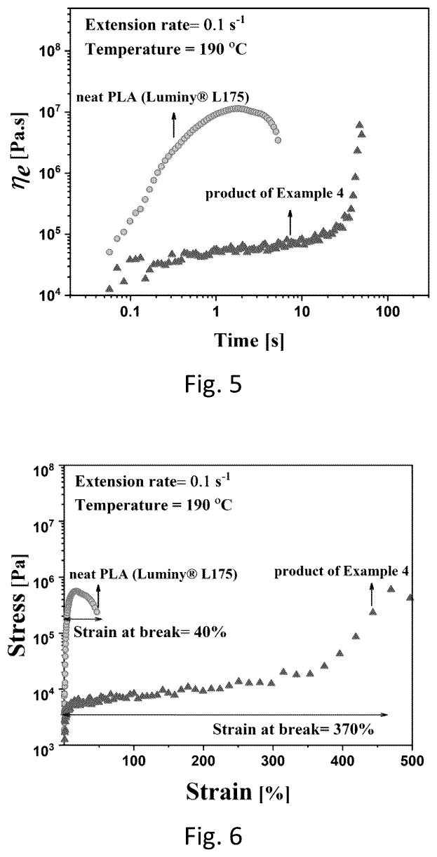

Example 1 was repeated except that 95 and 5 parts by mass of vacuum-dried PLLA and PDLA were melt blended and treatment at 190° C. for about 10 minutes. The rheological behavior of the compound was determined under uniaxial extensional flow at 190° C. In FIG. 5 and FIG. 6, the results of the tests are compared with the neat PLLA.

1. A method of producing a polylactic acid (PLA)-based material comprising the steps of:
(a) providing an amorphous blend comprising poly(L-lactic acid) (PLLA) and poly(D-lactic acid) (PDLA),
(b) bringing the blend provided in step (a) to a temperature (T_{C,HC}) of between glass transition temperature (T_{g}) and homocrystalline phase melting temperature (T_{m,HC}) of the blend and maintaining the temperature within this range until at least 5 J/g, of homo crystallites are formed with a melting temperature below 180° C., and
(c) bringing the resulting material of step (b) to a temperature (T_{SC}) above melting temperature of homocrystalline phase and maintaining the temperature within this range for a sufficient time t_{SC} to generate a poly(lactic acid)-based material with nano-sized stereocomplex crystals having a melting temperature higher than T_{m,HC}.

2. The method according to claim 1, wherein in step (a) the blend is provided via melt blending or solvent mixing.

3. The method according to claim 1, wherein the amorphous blend has weight ratio of PLLA:PDLA of between 5:95 and 95:5.

4. The method according to claim 1, wherein T_{C,HC} is between 70° C. and 155° C.

5. The method according to claim 1, wherein T_{SC} is between 170° C. and 230° C.

6. The method according to claim 1, wherein in step b) the blend is maintained at the temperature (T_{C,HC}) for at least 2 minutes.

7. The method according to claim 1, wherein in step c) the time t_{SC} is at least 30 seconds.

8. The method according to claim 1, wherein PLLA and PDLA in the amorphous blend are independently chosen from linear, branched or multibranched PLLA and PDLA resin.

9. The method according to claim 1, wherein the blend provided in step (a) comprises a linear, branched or multi-branched PLLA resin with an average molecular weight of more than 30 kDa, and/or
wherein the amorphous blend further comprises a copolymer od PLLA and PDLA, and/or
wherein the amorphous blend further comprises one or more components selected from the group of: minerals, fillers, fibers; and waste streams from agriculture, and/or
wherein the method further comprises a step of uniaxially and/or biaxially stretching of the material before, during or after step (b) and/or step (c).

10. (canceled)

11. (canceled)

12. (canceled)

13. A polylactic acid (PLA)-based material obtained or obtainable via the method of claim 1.

14. A polylactic acid (PLA)-based material comprising poly(L-lactic acid) (PLLA) and poly(D-lactic acid) (PDLA) and/or copolymers thereof, wherein the material contains at least 2% by weight, at least 5% by weight, at least 10% by weight, or at least 20% by weight, of nano-sized stereocomplex crystals, based on the total weight of the material.

15. The polylactic acid (PLA)-based material according to claim 14, wherein the material comprises less than 20 wt. % of additives.

16. The polylactic acid (PLA)-based material according to claim 14, wherein the weight ratio of PLLA:PDLA is between 5:95 and 95:5 and the combined weight of PLLA and PDLA forms at least 80% of the total weight of the material.

17. The polylactic acid (PLA)-based material according to claim 14, with a Heat Deflection Temperature of above 115° C., and/or
wherein the material is optically clear, and/or
wherein the material has a melt strength above 5.6 MPa at 190° C., and/or drawability of more than 40% at 190° C., and/or
wherein the PLA material exhibits strain-hardening behaviour when subjected to strain or deformation above 160° C.

18. (canceled)

19. (canceled)

20. (canceled)

21. A polylactic acid (PLA)-based material comprising poly(L-lactic acid) (PLLA), poly(D-lactic acid) (PDLA); wherein the combined weight of PLLA and PDLA forms at least 80 wt. % of the total weight of the material; and wherein the material has a Heat Deflection Temperature of above 115° C.; and/or a melt strength of above 5.6 MPa; and/or drawability of more than 40% at 190° C.; and/or the material is optically clear.

22. A polylactic acid (PLA)-based material comprising poly(L-lactic acid) (PLLA), poly(D-lactic acid) (PDLA), wherein the combined weight of PLLA and PDLA forms at least 80 wt. % of the total weight of the material, and wherein a sample of the PLA material exhibits strain-hardening behaviour when subjected to strain or deformation at a temperature above 160° C., and wherein the same sample of the PLA material no longer exhibits strain-hardening behaviour when subjected to strain or deformation subsequent to being heated to a minimum temperature of 210° C.

23. The polylactic acid (PLA)-based material according to claim 14, wherein the material comprises a plurality of nano-sized stereocomplex crystals that are deformed, elongated and/or oriented along the same direction.

24. A fiber, film, foam or sheet comprising the polylactic acid (PLA)-based material according to claim 13.

25. The fiber, film, foam or sheet according to claim 24, further comprising one or more components selected from the group of: minerals, fillers, fibers, and waste streams from agriculture.

26. A method of manufacturing a fiber, film, foam or sheet according to claim 24 comprising film blowing, thermoforming, foaming, filament extrusion, additive manufacturing and/or injection molding of the polylactic acid (PLA)-based material according to claim 13.

27. (canceled)
